(19) United States
(12) Patent Application Publication
(10) Pub. No.: US 2005/0122218 A1
(43) Pub. Date: Jun. 9, 2005

(54) Ranging and warning device using emitted and reflected wave energy

(76) Inventor: Christopher M. Goggin, Wilmington, NC (US)

Correspondence Address: KATTEN MUCHIN ZAVIS ROSENMAN, 575 MADISON AVENUE, NEW YORK, NY, 10022-2585, US

(21) Appl. No.: 10/730,157

(22) Filed: Dec. 6, 2003

(51) Int. Cl. G08B 13/18

(52) U.S. Cl. 340/552; 340/435; 342/90; 342/118

(57) ABSTRACT

A portable ranging and warning device adoptable to a variety of uses. The portable ranging and warning device uses a source of aimed wave energy to detect and recognize objects in proximity to the device. A beam of directed energy is sent from the device where it is reflected by the object and the reflected energy is received by a receiver on the device. A computer within the device can calculate the distance between the device and the object by the time delay between the pulsed directed energy beam and the return reflection. By sending sequential pulses of energy and varying the direction of the aim of the directed energy, a pattern of reflections may be stored in the computer's memory. This pattern of reflected energy may be compared to templates of reflected energy for particular objects. When there is a correlation between the reflected energy and the template, an object may be identified. The device then may take action based on that identification including generating warning through sound or visual displays.

### BACKGROUND OF THE INVENTION

1. Field of the Invention

This invention relates generally to a device that emits wave energy in defined directions. The wave energy hits a surrounding object and is reflected back to the device, which uses the time differential for reflected wave energy to calculate the distance between the device and the object. The device is designed to provide input regarding the calculated distance to a user in a variety of ways. The direction and elevation are determined by the position of the transmitter at the moment the signal is first sent. The ability to lock onto and track moving obstacles is provided in a predetermined range of directions around the device. Any obstacle that exceeds the desired range and closure rate will cause a warning or action such as interrupted cell phone calls, audible or visual alert, apply brakes, etc.

2. Description of Related Art

A variety of warning devices have been proposed to measure distance of objects from a vehicle or object, such as a truck, automobile, boat, airplane, industrial robot, or the like. Some of these devices are used in a large vehicle like a truck, or sports utility vehicle where the vision of an operator is obscured so that a proximity warning will help the operator of the vehicle avoid colliding with loading docks, garage walls, guard rails, or such similar obstructions that may be out of the line of sight of the operator of the vehicle. Other devices are designed to warn an operator of a motor vehicle of traffic hazards in front of the vehicle, which can include a stopped or suddenly slowing vehicle or even a vehicle or pedestrian entering the roadway in a collision course with the vehicle equipped with the warning device. For example, one commercially available retrofittable device for a motor vehicle has been sold by a company doing business as “Topix”, which uses a distance indicator unit mounted within the passenger cabin with a plurality of distance measuring sensors that are on the rear bumper. The internally mounted distance indicator unit provides a read-out of distance, as well as an audio reminder. Generally, parking radars can be provided in kit form for retrofit to motor vehicles. Typically, the sensor devices are peripherally mounted on a vehicle and electrically connected to an indicator unit mounted within the passenger compartment. One example of a retrofit device is the Paranjpe, U.S. Pat. No. 6,339,369, which uses a base unit located within a vehicle cabin with a plurality of remote units located around the peripheral of the vehicle. These remote units measure the distance between the vehicle and obstacles in proximity and communicate this information through the base unit through wireless means. The Nishimura, U.S. patent Publication No. 001/0024171 provides for compensation of a laser beam mounted on a vehicle to compensate for either the front or rear of the vehicle being lowered or raised due to declivities in the travel lane or for some other reason. The Rashid U.S. Pat. No. 3,898,652 uses a Doppler radar and proximity radars to provide for vehicle safety and protection system. This calculates the probability of a vehicle's potential to stop before colliding with an object detected in front of the vehicle and also provides information about objects closing from the rear of the vehicle. The Gustafson U.S. Pat. No. 6,014,601 configures a laser transmitter and receiver to a processing unit using input from the laser transmitter and receiver to calculate a safe following distance based on the road conditions and other information. The calculated time to collision is displayed on the collision time display and a light display indicates the relative level of danger of a collision with a vehicle in front of the vehicle equipped with the Gustafson's device.

Despite the above work, there is an unmet need for a device that locks onto and tracks moving obstacles, interfaces the present obstacle position with electronic controls such as speed controls, brakes, cell phones, is compact, inexpensive and versatile in application. Many of the current devices are “built in” or attached in such a fashion to a particular vehicle or circumstance that makes it impossible for a user to readily detach and move the device from one application to another. Moreover, many of the current inventions are unduly complex and expensive.

### SUMMARY OF THE INVENTION

One object of the current invention is to track a single moving obstacle that the user has selected, for example the unit will lock onto a license plate ahead of the user's vehicle. The device will constantly monitor and alert the user when present distances or direction parameters have been exceeded, i.e., rapid closures, rapid change in direction and minimum separation distance. It is an object of the invention to be compact in size and appearance roughly approximating commercially available devices known as “radar detectors” which are ordinarily less than one inch in thickness, six inches in length, and four inches in width. It is another objective of the current invention to be easily transportable from one application to another. For example, a user may wish to have it in use in a car or truck when traveling to a boat launch, but then to transfer the device to the boat once the boat is launched and in the water. Or, to use it in a car when traveling with a camper, but then to attach it to the camper once the campsite is set up. It is a further object of the invention in one compact unit to provide means for emitting and receiving directed energy in multiple directions, hence to warn of objects located in multiple directions from the device.

It is anticipated that the current invention would be similar in size and appearance to a “radar detector” hence less than 30 total cubic inches in volume. The device emits and receives a directed wave energy signal such as light, radio frequency, or sound. The preferred embodiment would ordinarily utilize a single coherent light emitting source like a laser. The coherent light source is movably fixed in a vertical orientation and focused to a beam steering assembly. The beam steering is accomplished with a 90 degree mirror positioned above the laser; the mirror bends the beam to the horizontal. The emitted beam rotates in the vertical plane as a result of spinning the mirror about the vertical axis and the emitted beam may articulate up and down relative to the vertical axis. The resulting beam path image may be thought of a sine wave as the beam simultaneously rotates through an arc of up to 360 degrees and pitches up and down.

The laser is switched on and off at timed intervals to create a set of points, which, when connected, form a sine-like wave. Each point resulting from a detected return is calculated for distance and assigned a position value based on the position of the light source at the time the returned signal was first transmitted. Each returned position is assigned a “1” value in a matrix stored in a program memory and a “0” value for no return, thereby mapping an image around the transmitter source. A group of images at various distances away from the unit are stored in memory. Stored matrix values before and after each scan are compared, thus relative motions and positions of multiple obstacles can be calculated and shown on a display monitor in real time. Separate stored matrix tables are used to recognize sought after profile shapes such as cars, license plates, pedestrians, boats, etc., and are therefore applied to any obstacle at any direction relative to the source. If, for example, a license plate image is recognized and appears in the path of the user's vehicle, a circle symbol superimposed on that target symbol and displayed as a “locked” obstacle. The system continues to detect that obstacle and if the calculated distance violated the minimum separation distance or closure velocity, a warning will be either displayed or a signal sent to another device. Vehicles in adjacent lanes are displayed but are not locked targets since they are not considered obstacles.

Reflections or objects of no interest are filtered out and ignored by the display, such as road signs, weather conditions, reflections, rocking motions of a boat, etc. The detector receiving the reflected transmitted signal is positioned above the rotating assembly and is stationary. The transmitter/detector assembly can be contained in the base unit or can be removable for placement in a position remote to the main base unit for a variety of uses. The sensitivity of the device can be adjusted so that the device would only respond to objects within certain distances.

The device could be readily moved from one application to another such as from a car to a boat, or to a camper, or to a tent. The device could use a variety of pulsed energy sources including ultrasonics, radar, or laser to measure distances. The device will be configured to alert users of objects within a predetermined fixed distance or circumstance both with audio and visual warnings. It could also be used to automatically deactivate such things as cruise control or autopilots or to generate a radio signal to provide audio input in a headset worn by a user. Others objects of the current invention will become apparent in the detailed description of the drawings which follows.

### BRIEF DESCRIPTION OF THE DRAWINGS

FIG. 1 and FIG. 1A shows an embodiment of the ranging and warning device in different perspective views.

FIG. 2 shows an embodiment emitter-detector in partial cut-a-way and above the base unit.

FIGS. 3, 3A, and 3B are a detailed view of laser and mirror of the laser emitter-detector and the resulting sine wave.

FIG. 4 is a block diagram with the main operating parts of the ranging and warning device.

FIG. 5 is a flow chart of the operation of the ranging and warning device.

FIG. 6 is a commercial embodiment of a laser ranging and warning device.

FIG. 7 is an exploded view of a commercial embodiment of a laser ranging and warning device.

FIG. 8 is a view of the controller board of a commercial embodiment of a laser ranging and warning device.

### DETAILED DESCRIPTION OF THE DRAWINGS

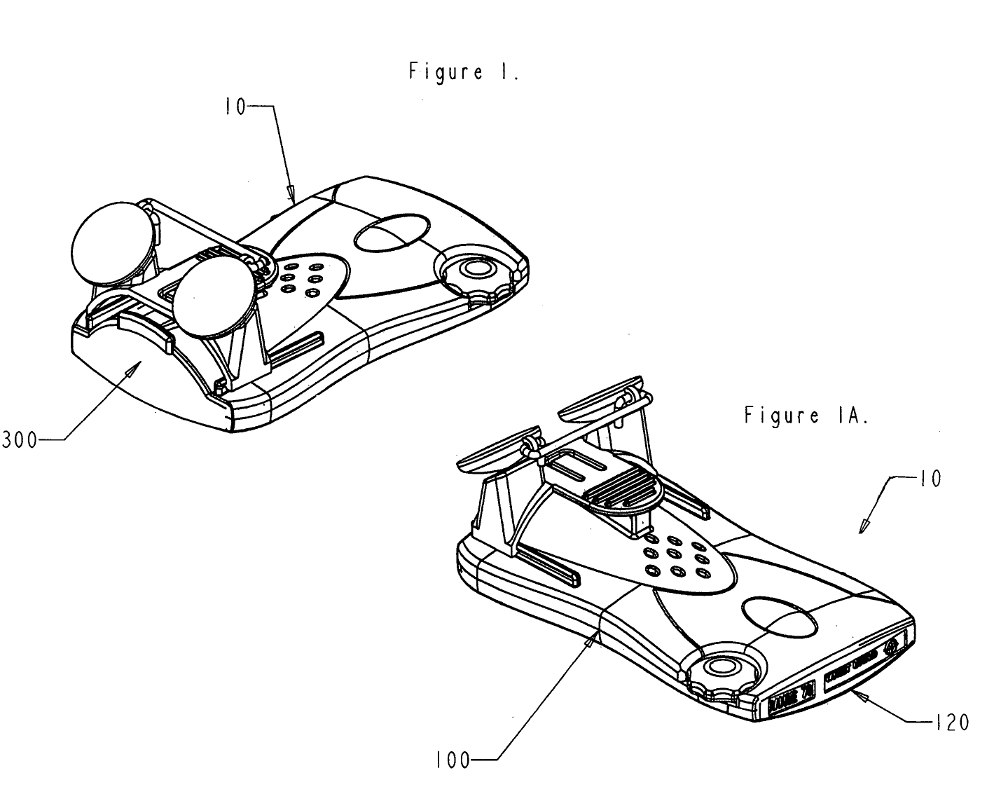

FIG. 1 and FIG. 1A show an embodiment of the ranging and warning device (10) in separate perspective views. The base unit (100) has an input/output screen (120). Snapped into the base unit (100) is the emitter-detector (300), which is shown in more detail in subsequent figures.

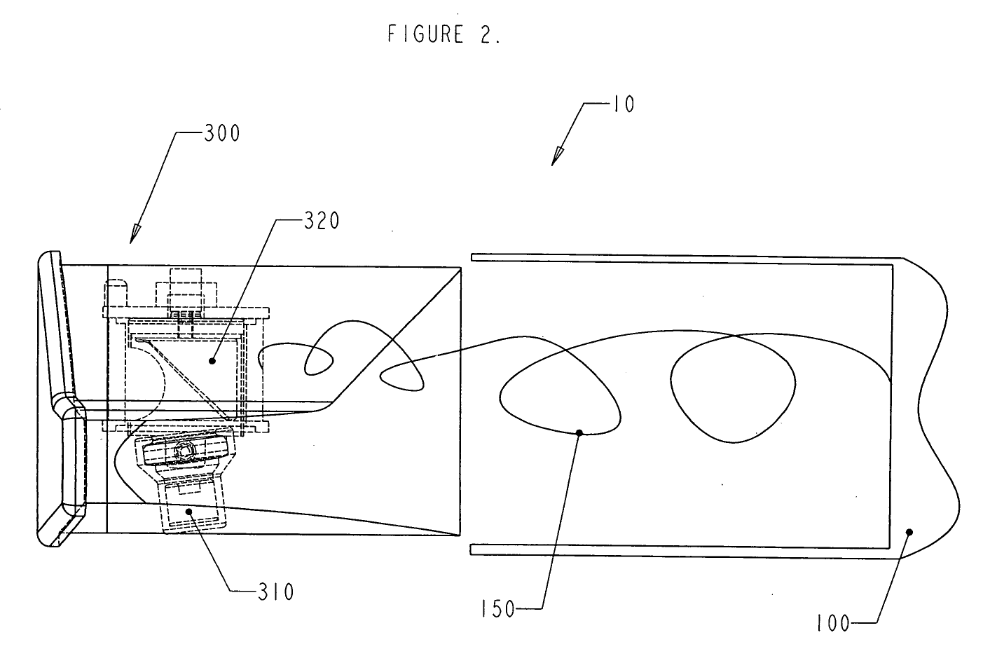

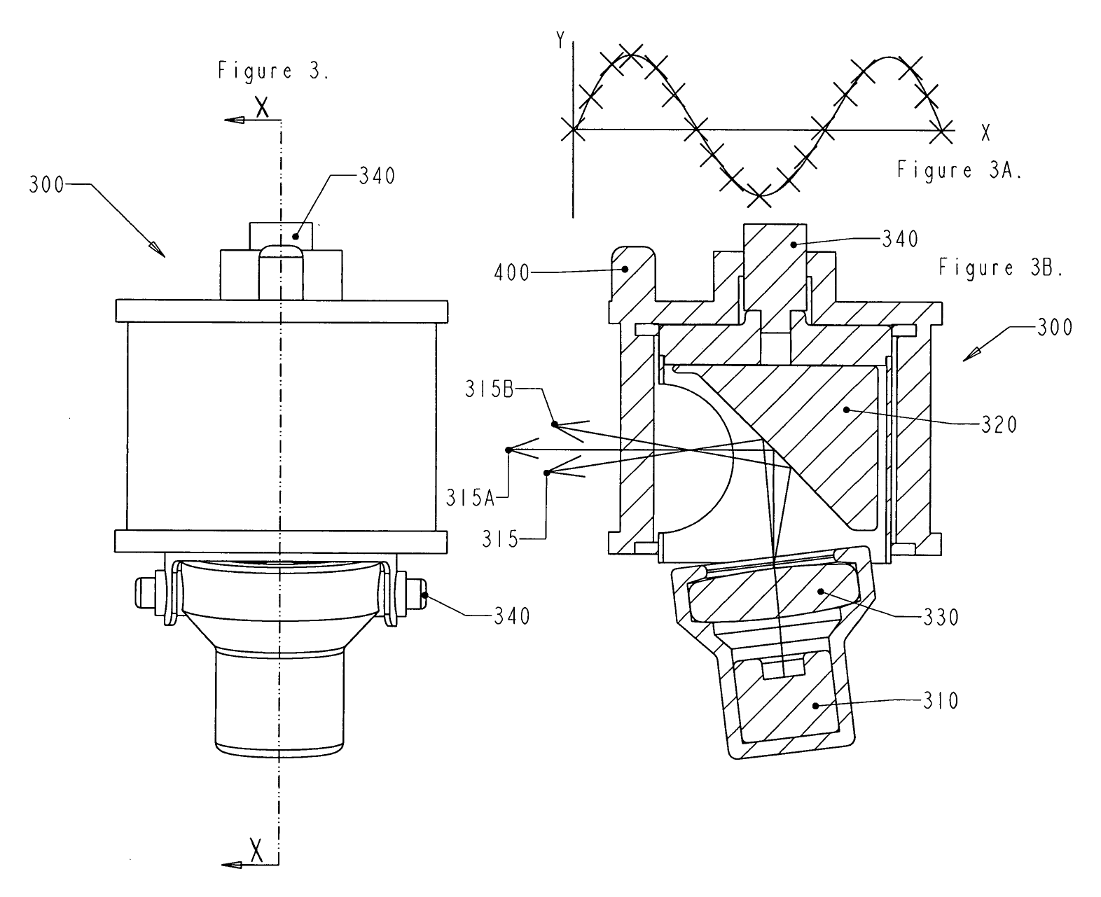

FIG. 2 shows in partial cut-a-way an embodiment of the ranging and warning device (10) with a removable laser emitter-detector (300). The base unit (100) is shown to the right of the laser emitter-detector (300). The laser emitter-detector (300) is operatively connected to the base (100). A variety of technologies could be employed to make the connection, including radio waves or infrared. However, it is expected in most applications the connection will be a small extendable electrical wire (150) as is shown in FIG. 2. In this embodiment the laser emitter-detector (300) may be removed from the base unit (100) for remote positioning. As shown in FIG. 2, there is a central laser emitter (310) with a rotating reflective mirror (320) positioned above the laser emitter (310) to redirect the laser beam of light to a roughly horizontal direction. For radio frequency (radar), the rotating mirror (320) would be replaced by a 90° wave guide and rotary joint. For a sonic or sound transmitter, it would be necessary to mount a transmitting transducer to approximate the role the rotating mirror (320) plays for a laser—that is, the transmitting transducer will rotate while also oscillating on a vertical axis, as is explained for the laser embodiment in FIG. 3.

FIG. 3 shows the laser emitter-detector (300), and motors (340). FIG. 3B is a cut-a-way view along line X-X in FIG. 3. Here, the laser emitter (310) is mounted on an axis for rotatable movement about the axis using motor (340). This means that the beam of light shown by the arrows in FIG. 3B reflects off the rotating mirror (320) at different points as the laser emitter (310) is rotated by a motor (340). The light beam and the respective reflections off the rotating mirror (320) are shown in an exaggerated fashion to better explain the interaction of the rotating mirror (320) with the laser emitter (310) and lens (330). When the motor (340) forces the laser emitter (310) to oscillate in a counter-clockwise fashion, the resulting angle of reflection for the light beam (315) generated by the laser emitter (310) off the rotating mirror (320) is below the horizontal. Two other light beams (315A, 315B) are shown to demonstrate the angle of reflection from the rotating mirror (320) when the laser emitter (310) is aimed vertical (light beam (315A)) and when the laser emitter (310) is rotated clockwise by motor (340) (light beam (315B)). The rotating mirror (320) is ordinarily mounted at a 45° angle to the vertical, which results in a 90° angle of reflection for the laser light beam (315) generated by the laser emitter (310). The rotation of the rotating mirror (320) and the oscillation of the laser emitter (310) are controlled by motors (340). Ordinarily, the laser emitter (310) will be pulsed—that is, it will send out a discreet light beam for a discreet period of time, then will be off for a discreet period followed by another discreet burst of laser light. Because the orientation of the laser emitter (310) and its associated light beam (315) is changing relative to the vertical, it will reflect from a different place in the mirror (320). FIG. 3A is a representation of the reflecting face of the rotating mirror (320) plotted on an X and Y axes. Each discreet point represents a reflecting point that the laser emitter (310) made when pulsed on. As the laser emitter (310) oscillates clockwise or counter-clockwise, the points of reflection of the light beam (315) on the mirror (320) move up and down in the Y axis. The rotating mirror (320) rotates in time through as much as a 360° rotation and this is shown as the X axis, which represents the time of rotation of the rotating mirror (320). The discreet points of reflection of the laser light generated by the laser emitter (310) on the rotating mirror (320), if connected, form a sine wave. If the rotation of the rotating mirror (320) is at a constant speed and the clockwise/counter-clockwise oscillation of the laser emitter (310) is also at a constant speed, it will result in dots that may be connected into a regular sine wave with a constant amplitude and frequency. The SINE wave is based on Y (x)=A SINE (x+bx^{N}). In Y (x)=A SINE (x+bx^{N}) the variable include “A” for the amplitude, “x” for the angular or rotational variable and “b” and “n” are the compression or expansion variables. Changing the variable “A” controls the height of the sweep, “x” controls the amount of rotation from zero to 360° and “b” and “n” control the amount of compression or expansion of the sine wave depending on the amount of resolution.

For radio frequency, a 90° wave guide with a RF horn will serve to redirect a radio frequency signal from the vertical to the approximate horizontal serving the same function as the rotating mirror (320) does for the laser emitter (310) embodiment. As with the laser, the radio frequency source can oscillate around the vertical. As the radio frequency source is pulsed on and off as it oscillates and wave guide with the RF horn rotates, a sine wave distribution as in FIG. 3A is formed. A sound source would work similarly, but instead of a rotating mirror (320) a sound emitting transducer would be mounted on a rotating and oscillating base. Again, as the sound transducer is pulsed on and off, it will make a series of points when connected, form a sine wave, as is shown in FIG. 3A. A detector (400) is shown positioned to receive reflected energy generated by the laser emitter (310) or radio frequency for a radio emitter or sound emitter as will be explained later. A detector (400) receives reflected energy either from the laser (310), a radio frequency source or a sound source, which can then be used to determine if a caution or warning is appropriate.

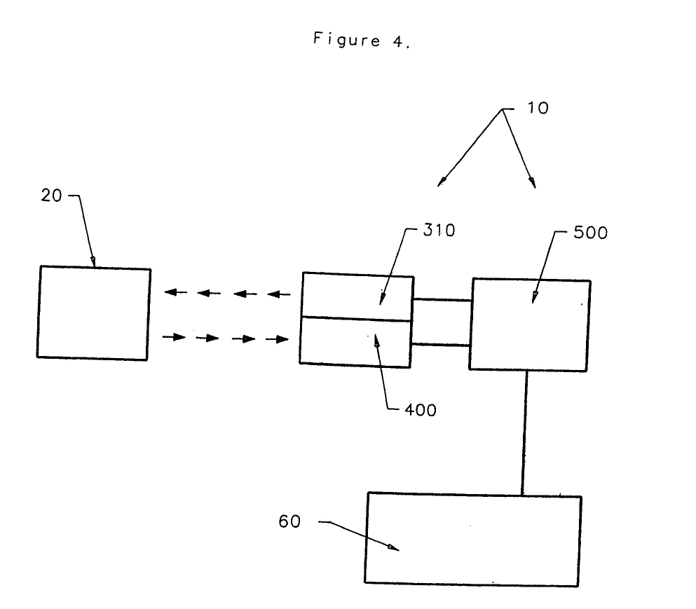

FIG. 4 shows in block diagram the operation of the ranging and warning device (10). There is an emitter (310), ordinarily a laser, and a receiver (400) connected to a controller (500), which is also connected to an output unit (60). The controller (500) controls the emitter (310), which will ordinarily send a pulsed series of energy waves, be the waves laser light, sound, or radio frequency. As shown in FIGS. 3, 3A, and 3B, the rotating mirror (320) (for a laser (310)) reflects the light emitted, forming a curve which may form a sine wave pattern. This results in reflected energy being received by the receiver (400). Because the reflected energy returns at discreet times from discreet points of reflection, the different strengths and locations of reflected energy can be reported to controller (500). This returned data can be analyzed by the controller (500) using a microprocessor. The microprocessor may also control the laser emitter (310), hence the microprocessor can remember and know how the beam of energy from the laser emitter (310) was oriented at the time a pulse was made, which is matched with the reflected pulse of energy. Therefore, the object (20) will be repeatedly pulsed with a beam of directed energy and return a directed energy reflected pulse in a short period of time. This data is stored in the microcontroller in the controller (500). This stored pattern of reflected energy may be compared by the microcontroller to a template. Particular types of objects that are of interest to the ranging and warning device (10) will have stored templates for comparison to the reflected energy received by the receiver (400). For example, a truck would have a template, an animal like a deer would have a different template, a car would have a third kind of template, and so on. A group of stored templates representing profile shapes of particular objects (20) will be stored in the memory of the controller (500). For example, a solid profile for a pedestrian would be between five and six feet tall with a 20-inch wide generally vertical rectangle. The rear of a truck could be an 8-foot wide by 10-foot tall rectangle. A license plate would be the standard 15″×8″ horizontal rectangle. An object like a license plate would be targeted and tracked. When they are returned reflected light beams received by the reciever (400), the controller (500) would attempt to match the returned data through the profile or templates in memory. If a match is recognized, then, depending on the programming of the controller (500), the equation variables (A, x, b,N) can be changed by the controller (500) so as to focus the laser emitter (310) more closely on or solely on the object (20) to be tracked. Again, according to programming, if no match is found for the object (20), the object (20) may be ignored. Different stored templates representing objects (20) could be used for different applications. For example, a ranging and warning device (10) to be used for a boat might have a different stored set of templates than one to be used for an automobile, which would still be different from one to be used by campers. The laser ranging and warning device (10), as will be explained later, can measure distances, hence, it will be easily understood that the controller (500) can scale the size of the objects relative to the distance from the ranging and warning device (10) making it possible to match the returned data to the templates stored in the controller (500) for objects (20) of particular interest. In this fashion, the controller (500) can recognize objects that are within range and are returning reflected energy, if the reflected energy matches the stored template.

The microcontroller can also, of course, know when a pulsed energy was sent by the emitter (310) and the reflected pulse was received by the receiver (400). The difference in time between the time the pulse was sent and the time a reflection returned allows the microcontroller in the controller (500) to calculate a distance. The distance for each identified object may be also stored. This allows the controller (500) to keep a record of what objects of interest are within range of the ranging and warning device (10) and to record the ranges as they change over time. This allows the ranging and warning device (10) through the controller (500) to take action based on a pre-programmed set of instructions regarding how to respond to the data received and stored in the microcontroller from the emitter (310) and the receiver (400). For example, in an automobile use, the ranging and warning device (10) might record that a truck was 300 feet directly ahead of the ranging and warning device (10). If the vehicle in which the ranging and warning device (10) was placed was traveling faster than the truck ahead, over time the distance between the object (20) (here a truck) and the ranging and warning device (10) would decrease. The ranging and warning device (10) could be set to give a caution tone when the range was within one distance and a warning tone if the range decreased to a second dangerous distance.

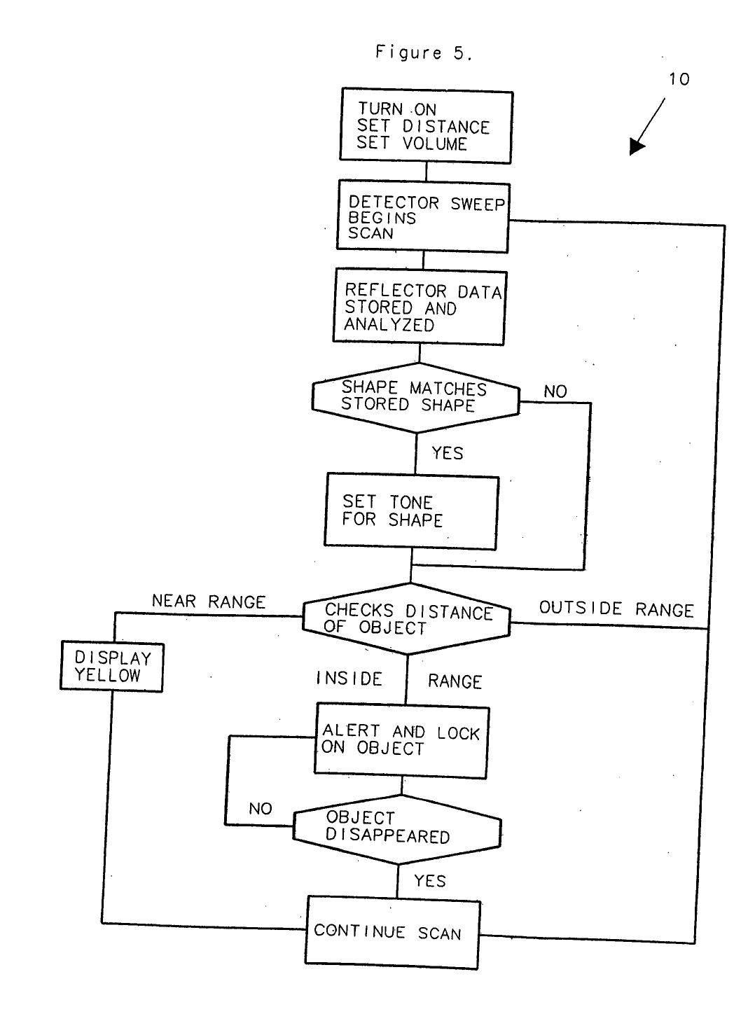

A flow chart of the operation of the ranging and warning device (10) is shown in FIG. 5. The ranging and warning device (10) is turned on, a warning distance is set, and a volume of the output unit (60) is set. The detector sweep begins so the emitter (310) would begin to emit pulses of directed radiation, which would be reflected back by objects (20) and received by the receiver (400). The data regarding the direction of the beam of focused energy sent by the emitter (310) and the data for the reflected beam of the pulse of directed energy sent by the emitter (310) will be received by the receiver (400) all of which will be recorded by a microcontroller within the controller (500). The pulses ordinarily are rapid and result in a scan across a particular arc. For example, in a ranging and warning device (10) placed inside of a vehicle, the beam of emitted energy may pass through the windshield and may be directed primarily in a fairly narrow arc of around 15° in front of the vehicle. On the other hand, in a marine application, the arc of sweep may be 360°. Once the scan begins, the reflection data is stored and analyzed. This means that the reflected energy points will be compared to the templates stored within the microcontroller within the controller (500). If the shape of the reflected energy matches a stored template shape, then the output unit (60) may emit a tone for that particular shape. There might be one tone for a truck, another tone for a car, and a third tone for a pedestrian. Using the time differential between the time the pulse of energy is emitted by the emitter (310) and received by the receiver (400), the microcontroller within the controller (500) may determine the distance of the object (20). If the object (20) is outside of the range, then the detector sweep continues without any further action from the ranging and warning device (10). If the object (20) is near a predetermined range, which was set at the time the ranging and warning device (10) was activated, a caution light (yellow) and tone may be sounded to advise the operator that a particular object (20) is within a particular range. If the object (20) then is determined to be inside of a range, the microcontroller within the controller (500) may discontinue the scan and lock on the object (20) while providing a particular warning alert. In other words, if a pedestrian moves within the front of a vehicle, the microcontroller within the controller (500) may determine that there is a particular danger, sound a warning tone, and focus its emission of directed energy by the emitter (310) on the pedestrian until the microcontroller determines the danger is over when the pedestrian has left the preset distance. Once the object (20) has left the distance, the scan continues. In this fashion the device may caution of objects within a particular range by a tone matched to the object's shape and give a stronger warning when the object is within a dangerous distance.

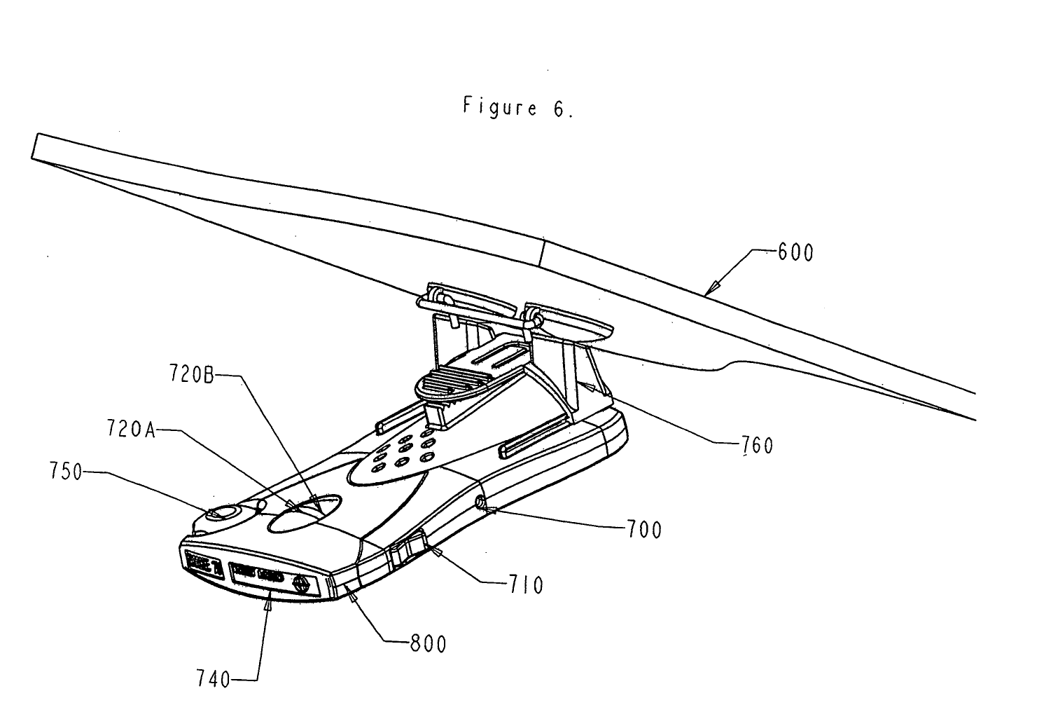

FIG. 6 shows a potential commercial embodiment of a specific laser ranging and warning device (800). It will ordinarily be mounted to a car windshield (600) by a suction mount (760). The power may be supplied by a battery (not shown in FIG. 6) or a jack (700) for a connection to the car power outlet. An on-off switch (710) will control the operation of the device. A range control knob (750) sets the sensitivity of the ranging and warning device (800). Volume control knobs (720A) and (720B) respectively decrease or increase the volume of warning sounds that may be emitted by the laser range warning device (800). An LED display (740) displays visual information of findings of the device.

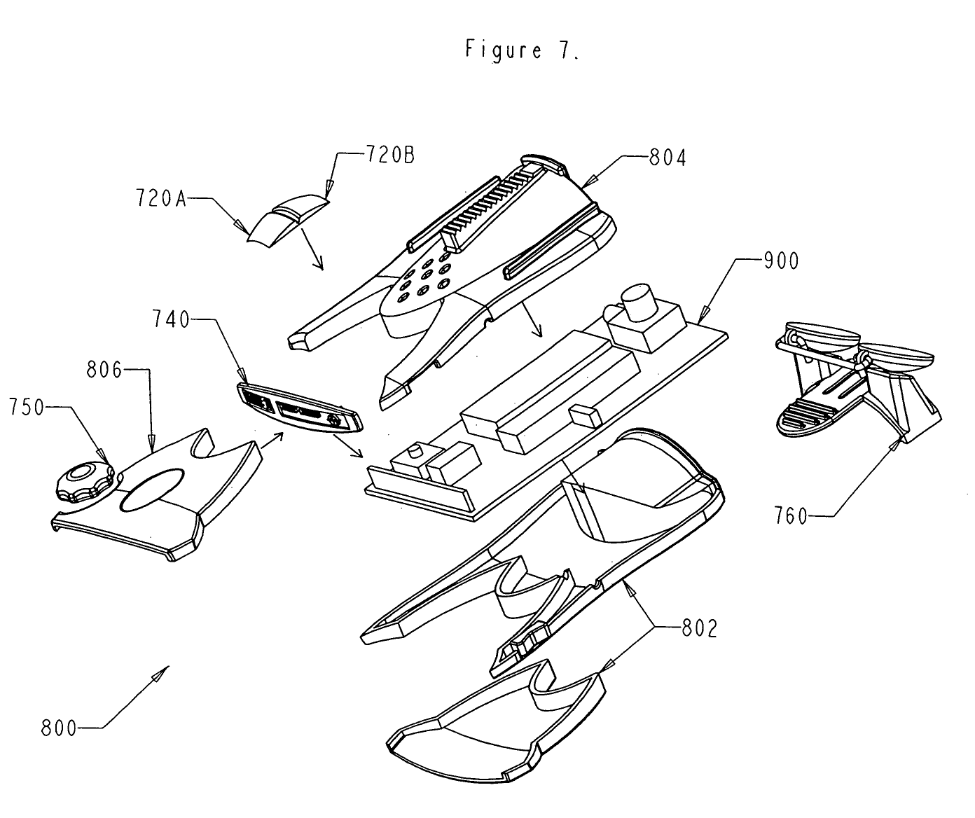

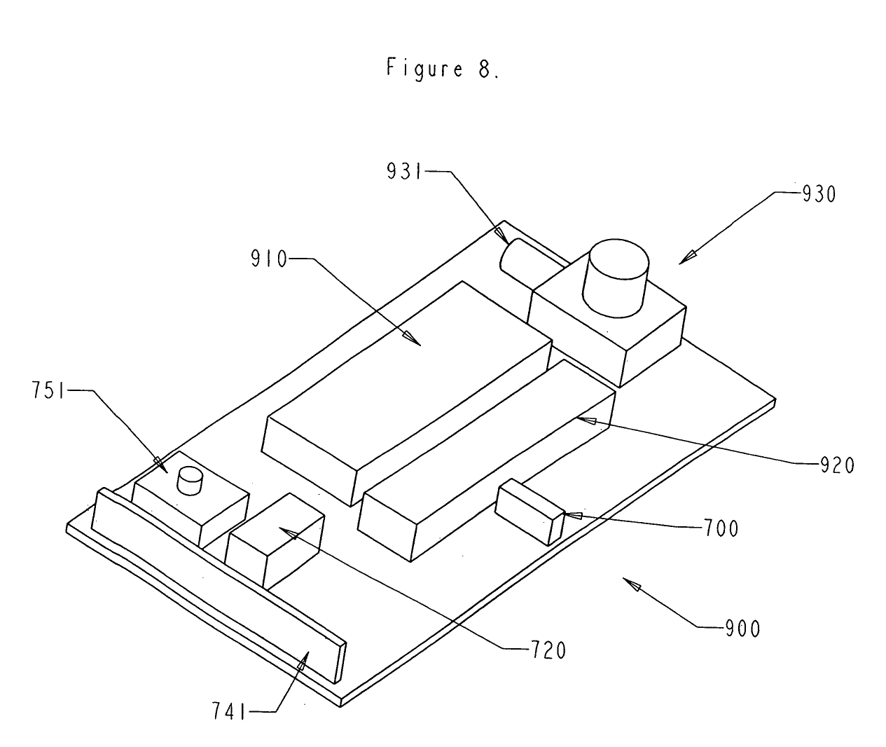

FIG. 7 shows an exploded view of the main pieces of the laser ranging and warning device (800). The suction mount (760) is detached from the bottom shell (802). The controller board (900) which will be shown in more detail in FIG. 8 fits within the bottom shell (802) where it will be covered by the top shell (804) and the front shell (806). The range adjustment (750) snaps into the front shell (806) and connects to the controller board (900) as does the volume control (720A) and (720B). The LED display cover (740) fits on the front of the controller board (900) between the front shell (806) and the bottom shell (802).

FIG. 8 shows the control board (900)and the main parts of the laser ranging and warning device (800). The controller board (900) uses micro controller (910) as the main memory and computational part of the control board (900) for the laser ranging and warning device (800). A number of different chips or chip sets could be used. However, it has been found in practice that a Texas Instruments chip, assigned parts number MSP430, can do the calculation, memory, and controlling functions required of the controller (500) shown in the block diagram in FIG. 4. A part of the controller function (500) will be a chronometer or range controller (920). This receives and calculates time delay data from the laser emitter and receiver (930). It has been found in practice that for the controller chronometer (920) a device sold by E.O. Devices and assigned parts number ERC-2A will serve in the laser ranging and warning device (800). For a controller (920) of this type, it requires an emitter and receiver (930). It has been found in practice that again devices manufactured by E.O. Devices are satisfactory. The pulse laser may use a device manufactured by E.O. Devices and assigned parts number ETX-4X as a diode driver which, coupled with a pulse laser diode from Opto Semi-Conductors assigned parts number SPLPL90, send appropriate pulsed laser beams with a wave length of 905 nanometers. The reflected laser light from an object of interest may be received by a photo diode optical receiver. One that has been found to serve in practice is manufactured by E.O. Devices and assigned parts number ERX-5X. A 12-volt powerjack (700) is seen on the right side of FIG. 8. A range adjustment rheostat (751) is connected to the range adjustment knob (750) and a sound output and control (720) is connected to the sound output control knobs (720A and 720B). Not shown in this view is an ON/OFF switch (7 10) which controls the provision of power through the 12-voltjack (700). An LED display (741) is on the front of the controller board (900). A servo motor (931) controls a mirror and lens (not shown in FIG. 8) which can be seen in FIG. 3 and FIG. 3B. This servo motor (931) provides the appropriate rotational and vertical movement of the laser emitting diode so that a sweep may be generated for calculation and reception by the other parts of the control board (900).

1. A ranging and warning device comprising:
(a) means for emitting a beam of directed energy waves,
(b) means for receiving said directed energy waves reflected by an object,
(c) means for calculating the distance between an object and said means for detecting,
(d) means for recording data generated by said reflected directed energy waves.

2. A ranging and warning device of claim 1 further comprising means for varying direction of said means for emitting whereby direction of said directed energy waves emitted by said means for emitting may be varied by said means for varying causing said directed energy waves to form a pattern.

3. A ranging and warning device of claim 2 wherein said means for emitting a beam of directed energy waves may be pulsed on and off whereby said means for varying uses said means for emitting to form a pattern of points of reflected pulsed directed energy.

4. A ranging and warning device of claim 3 further comprising a means for computing whereby said means for computing stores templates of data generated by a particular object that reflects pulsed directed energy, said means of computing compares said stored templates of data to data recorded by said means for recording.

5. A ranging and warning device of claim 4 wherein said means for emitting a beam of directed energy waves is laser light.

6. A ranging and warning device of claim 5 wherein said means for varying further includes a means for varying direction of said pulsed laser light in a vertical direction and means for varying direction of said pulsed laser light in a horizontal direction.

7. A ranging and warning device of claim 6 wherein said pattern of reflected points, if connected, form a sine wave.

8. A ranging and warning device of claim 7 wherein said means for computing controls said means for varying whereby said means for computing may use said means for varying to change said means for emitting so that a amplitude and a frequency of said sine wave pattern of connected points may be changed thereby permitting adjustments in the resolution in said sine wave pattern of connected points.

9. A ranging and warning device of claim 8 further comprising an output display controlled by said means for computing whereby a user may observe said output display.

10. A ranging and warning device of claim 9 wherein said output display further includes a sound generator for generating a plurality of sounds.

11. A ranging and warning device of claim 10 wherein said output display includes a plurality of distinct sounds whereby said means for computing causes said output display to make a particular distinct sound whenever said stored template of data matches recorded data.

12. A ranging and warning device of claim 11 wherein said means for computing uses said means for varying to change amplitude and frequency of said sine wave patterns wherein said stored template of data matches recorded data whereby said ranging and warning device focuses said beam of directed energy waves on said particular object.

13. A ranging and warning device of claim 4 wherein said means for emitting a beam of directed energy waves is radio waves of a predetermined frequency.

14. A ranging and warning device of claim 13 wherein said means for varying further includes a means for varying direction of said pulsed radio waves in a vertical direction and means for varying direction of said pulsed radio waves in a horizontal direction.

15. A ranging and warning device of claim 14 wherein said pattern of reflected points, if connected, form a sine wave.

16. A ranging and warning device of claim 15 wherein said means for computing controls said means for varying whereby said means for computing may use said means for varying to change said means for emitting so that a amplitude and a frequency of said sine wave pattern of connected points may be changed thereby permitting adjustments in the resolution in said sine wave pattern of connected points.

17. A ranging and warning device of claim 16 further comprising an output display controlled by said means for computing whereby a user may observe said output display.

18. A ranging and warning device of claim 17 wherein said output display further includes a sound generator for generating a plurality of sounds.

19. A ranging and warning device of claim 18 wherein said output display includes a plurality of distinct sounds whereby said means for computing causes said output display to make a particular distinct sound whenever said stored template of data matches recorded data.

20. A ranging and warning device of claim 19 wherein said means for computing uses said means for varying to change amplitude and frequency of said sine wave patterns wherein said stored template of data matches recorded data whereby said ranging and warning device focuses said beam of directed energy waves on said particular object.

21. A ranging and warning device of claim 4 wherein said means for emitting a beam of directed energy waves is sound waves of a predetermined frequency.

22. A ranging and warning device of claim 21 wherein said means for varying further includes a means for varying direction of said pulsed sound waves in a vertical direction and means for varying direction of said pulsed sound waves in a horizontal direction.

23. A ranging and warning device of claim 22 wherein said pattern of reflected points, if connected, form a sine wave.

24. A ranging and warning device of claim 23 wherein said means for computing controls said means for varying whereby said means for computing may use said means for varying to change said means for emitting so that a amplitude and a frequency of said sine wave pattern of connected points may be changed thereby permitting adjustments in the resolution in said sine wave pattern of connected points.

25. A ranging and warning device of claim 24 further comprising an output display controlled by said means for computing whereby a user may observe said output display.

26. A ranging and warning device of claim 25 wherein said output display further includes a sound generator for generating a plurality of sounds.

27. A ranging and warning device of claim 26 wherein said output display includes a plurality of distinct sounds whereby said means for computing causes said output display to make a particular distinct sound whenever said stored template of data matches recorded data.

28. A ranging and warning device of claim 27 wherein said means for computing uses said means for varying to change amplitude and frequency of said sine wave patterns wherein said stored template of data matches recorded data whereby said ranging and warning device focuses said beam of directed energy waves on said particular object.

29. A method for determining a distance between a device and an object and taking action in response to that determination of a distance comprising the steps of:
(a) emitting a beam of directed energy waves;
(b) receiving said directed energy waves when reflected by an object;
(c) calculating the distance between an object and the device;
(d) generating data from said reflected directed energy waves;
(e) recording said data.

30. A method for determining a distance between a device and an object and taking action in response to that determination of a distance of claim 29 further comprising the step of varying the direction of said emitted beam of directed energy waves.

31. A method for determining a distance between a device and an object and taking action in response to that determination of a distance of claim 30 further comprising the step of pulsing said emitted beam of directed energy waves on and off whereby said reflected directed energy waves is used to generate a set of data points.

32. A method for determining a distance between a device and an object and taking action in response to that determination of a distance of claim 31 further comprising storing templates of data generated by reflected pulsed directed energy from a particular object and comparing said stored templates of data generated by a particular object to data points generated by said reflected directed energy waves thereby determining if said template matches said data points.

33. A method for determining a distance between a device and an object and taking action in response to that determination of a distance of claim 32 wherein said step of emitting a beam of directed energy waves is emitting laser light.

34. A method for determining a distance between a device and an object and taking action in response to that determination of a distance of claim 33 wherein said step of varying the direction includes varying direction of said laser light on a vertical plane and varying direction of said laser light on a horizontal plane.

35. A method for determining a distance between a device and an object and taking action in response to that determination of a distance of claim 34 wherein said set of data points of reflected laser light if connected form a sine wave.

36. A method for determining a distance between a device and an object and taking action in response to that determination of a distance of claim 35 which includes a step of providing a controlling computer to control said step of varying the direction so that an amplitude and frequency of said sine wave pattern of reflected data points may be changed thereby permitting adjustment in the resolution of said pattern of reflected data points.

37. A method for determining a distance between a device and an object and taking action in response to that determination of a distance of claim 36 wherein said step of providing a controlling computer further comprises a step of providing an output display for said controlling computer.

38. A method for determining a distance between a device and an object and taking action in response to that determination of a distance of claim 37 wherein said step of providing an output display further includes providing a sound generator for generating a plurality of sounds.

39. A method for determining a distance between a device and an object and taking action in response to that determination of a distance of claim 38 wherein said step of providing a sound generator for generating a plurality of sounds further includes the stp of providing a plurality of distinct sounds whereby said controlling computer causes said sound generator to make a particular distinct sound whenever said pattern of reflected data points matches a template of stored data points.

40. A method for determining a distance between a device and an object and taking action in response to that determination of a distance of claim 39 wherein said step of providing a controlling computer further comprises the step of using said controlling computer to vary the amplitude and frequency of said sine wave patterns whenever said stored template of data matches said reflected data points whereby said beam of directed energy wave is aimed at said particular object.

41. A method for determining a distance between a device and an object and taking action in response to that determination of a distance of claim 32 wherein said step of emitting a beam of directed energy waves is emitting radio waves of a predetermined frequency.

42. A method for determining a distance between a device and an object and taking action in response to that determination of a distance of claim 41 wherein said step of varying the direction includes varying direction of said radio waves on a vertical plane and varying direction of said radio waves on a horizontal plane.

43. A method for determining a distance between a device and an object and taking action in response to that determination of a distance of claim 42 wherein said set of data points of reflected laser light if connected form a sine wave.

44. A method for determining a distance between a device and an object and taking action in response to that determination of a distance of claim 43 which includes a step of providing a controlling computer to control said step of varying the direction so that an amplitude and frequency of said sine wave pattern of reflected data points may be changed thereby permitting adjustment in the resolution of said pattern of reflected data points.

45. A method for determining a distance between a device and an object and taking action in response to that determination of a distance of claim 44 wherein said step of providing a controlling computer further comprises a step of providing an output display for said controlling computer.

46. A method for determining a distance between a device and an object and taking action in response to that determination of a distance of claim 45 wherein said step of providing an output display further includes providing a sound generator for generating a plurality of sounds.

47. A method for determining a distance between a device and an object and taking action in response to that determination of a distance of claim 46 wherein said step of providing a sound generator for generating a plurality of sounds further includes the stp of providing a plurality of distinct sounds whereby said controlling computer causes said sound generator to make a particular distinct sound whenever said pattern of reflected data points matches a template of stored data points.

48. A method for determining a distance between a device and an object and taking action in response to that determination of a distance of claim 47 wherein said step of providing a controlling computer further comprises the step of using said controlling computer to vary the amplitude and frequency of said sine wave patterns whenever said stored template of data matches said reflected data points whereby said beam of directed energy wave is aimed at said particular object.

49. A method for determining a distance between a device and an object and taking action in response to that determination of a distance of claim 48 wherein said step of emitting a beam of directed energy waves is emitting sound waves.

50. A method for determining a distance between a device and an object and taking action in response to that determination of a distance of claim 49 wherein said step of varying the direction includes varying direction of said sound waves on a vertical plane and varying direction of said laser light on a horizontal plane.

51. A method for determining a distance between a device and an object and taking action in response to that determination of a distance of claim 50 wherein said set of data points of reflected laser light if connected form a sine wave.

52. A method for determining a distance between a device and an object and taking action in response to that determination of a distance of claim 51 which includes a step of providing a controlling computer to control said step of varying the direction so that an amplitude and frequency of said sine wave pattern of reflected data points may be changed thereby permitting adjustment in the resolution of said pattern of reflected data points.

53. A method for determining a distance between a device and an object and taking action in response to that determination of a distance of claim 52 wherein said step of providing a controlling computer further comprises a step of providing an output display for said controlling computer.

54. A method for determining a distance between a device and an object and taking action in response to that determination of a distance of claim 53 wherein said step of providing an output display further includes providing a sound generator for generating a plurality of sounds.

55. A method for determining a distance between a device and an object and taking action in response to that determination of a distance of claim 54 wherein said step of providing a sound generator for generating a plurality of sounds further includes the stp of providing a plurality of distinct sounds whereby said controlling computer causes said sound generator to make a particular distinct sound whenever said pattern of reflected data points matches a template of stored data points.

56. A method for determining a distance between a device and an object and taking action in response to that determination of a distance of claim 55 wherein said step of providing a controlling computer further comprises the step of using said controlling computer to vary the amplitude and frequency of said sine wave patterns whenever said stored template of data matches said reflected data points whereby said beam of directed energy wave is aimed at said particular object.

57. A portable laser ranging and warning device comprising:
(a) a laser emitter adjustably aimed whereby an aimed pulse of laser light emitted by said emitter may be sequentially directed in a plurality of directions;
(b) a receiver for receiving reflected laser light from an object, said reflected laser light originally emitted by said laser emitter;
(c) a computer including a memory, a calculator, a timer, and a controller; said computer operatively connected to said laser emitter and said receiver;
(d) at least one pattern of stored data points in said computer memory whereby said computer can compare data points generated by said receiver from said reflected laser light and thereby recognize correlations between said pattern of stored data points and said generated data points;
(e) an output operatively connected to said computer.

58. A portable laser ranging and warning device of claim 57 wherein said computer controls said laser emitter to emit sequential pulses of laser lights varying in both horizontal and vertical directions whereby said sequential pulses of laser lights, if connected, form a sine wave.

59. A portable laser ranging and warning device of claim 58 wherein said computer may change said aimed pulses of laser light so that said sine wave may be adjusted both for amplitude and frequency.
